(19) United States
(12) Patent Application Publication
(10) Pub. No.: US 2014/0009055 A1
(43) Pub. Date: Jan. 9, 2014

(54) LATCH APPARATUS AND REFRIGERATOR HAVING THE SAME

(71) Applicant: SAMSUNG ELECTRONICS CO., LTD., Suwon-si (KR)

(72) Inventors: Byoung Jae CHO, Gwangju (KR); Sang Hoon Lee, Yongin-si (KR)

(21) Appl. No.: 13/921,237

(22) Filed: Jun. 19, 2013

(30) Foreign Application Priority Data
Jul. 9, 2012 (KR) 10-2012-0074617

(51) Int. Cl. E05C 1/08; F25D 23/02

(52) U.S. Cl. CPC E05C 1/08; F25D 23/028
USPC 312/405; 292/224

(57) ABSTRACT

A refrigerator includes a latch apparatus configured to lock and release a home bar door. The latch apparatus includes a locking rod and a switch at an upper side of the home bar door and includes a pressing part at a front surface of the switch and a protrusion part protruding to a rear surface of the switch. A case is provided at an upper side of an opening corresponding to the position of the switch and includes a guide rail having an elliptical moving path, a rotatable cam having one end installed inside the case and other end having a locking groove with which the locking rod is locked and released, a moving shaft movable along the guide rail, a stopper to fix and release the moving shaft, and a torsion spring connected to the cam and the moving shaft.

### CROSS-REFERENCE TO RELATED APPLICATIONS

This application claims the benefit of Korean Patent Application No. 10-2012-0074617, filed on Jul. 9, 2012 in the Korean Intellectual Property Office, the disclosure of which is incorporated herein by reference.

### BACKGROUND

1. Field

One or more embodiments relate to a latch apparatus and a refrigerator having the same.

2. Description of the Related Art

In general, a refrigerator represents an apparatus having a compressor, a condenser, an expansion device and an evaporator as main components thereof to form a cooling cycle, and as a refrigerant of liquid state that flows inside the evaporator absorbs heat at an inside a storage chamber in a process of evaporation of the refrigerant, is configured to keep various food stored in the storage chamber in a cooling state or a frozen state for a long period of time.

In recent years, with the growth in demand for a large-scale and high-quality refrigerator according to the improvement of living environment, a refrigerator having a large interior capacity of a storage chamber is widely used.

However, since the refrigerator increases power consumption in the trend of a large-scale of the storage chamber, a recent development has tended toward a refrigerator configured in a way that a home bar provided with a handy storage chamber is installed at an inside of one door of a storage chamber so that when simple stocks such as beverage are taken out, the stock in the storage of the home bar storage chamber is easily taken out only by opening a home bar door without opening the whole door of the refrigerator.

At the home bar, a home bar door is installed to open and close an opening that is formed by removing a portion of the door so as to allow the inside of the refrigerator to be reached from outside of the refrigerator. In general, the home bar door is provided with a latch apparatus to close and open the opening formed in the door.

### SUMMARY

Therefore, one or more embodiments relate to a refrigerator capable of easily opening a home bar door by improvement of a structure of a latch apparatus configured to allow a home bar door to be locked and released when the home bar door is open and closed.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

The foregoing described problems may be overcome and/or other aspects may be achieved by one or more embodiments of a refrigerator including a body, a door configured to open and close a front surface of the body and having an opening, a home bar door configured to open and close the opening, and a latch apparatus configured to lock and release the home bar door, the latch apparatus including a locking rod, a switch, a case, a cam, a moving shaft, a stopper and a torsion spring. The locking rod may be provided at an upper side of the home bar door and may allow the home bar door to be locked and released. The switch may be provided at an upper side of the home bar door, and may include a pressing part provided at a front surface of the switch and a protrusion part connected to the pressing part while protruding to a rear surface of the switch. The case may be provided at an upper side of the opening while corresponding to a position of the switch, and the case may be provided at an inside thereof with a guide rail having an elliptical moving path in a front and rear side direction. The cam may have one end installed at the inside of the case so as to be rotatable in the front and rear side direction and another end provided with a locking groove with which the locking rod is locked and released. The moving shaft may be provided so as to be movable in the front and rear side direction along the guide rail. The stopper may be provided at the inside of the case so as to be rotatable in an upper and lower side direction to fix and release the moving shaft. The torsion spring may have one side connected to the cam and another side connected to the moving shaft so that, when the home bar door is closed, the other side of the torsion spring connected to the moving shaft is fixed and the one side of the torsion spring connected to the cam is moved to a rear side together with the cam and pressed. In a state that the home bar door is closed, when the pressing part is pressed such that the protrusion part pushes the stopper, the stopper may rotate to a lower side direction, and thus the moving shaft may be moved to the rear side along the guide rail by a compression force of the torsion spring being pressed, and when the moving shaft is moved to the rear side, the cam may be moved to a front side by a remaining compression force of the torsion spring, thereby opening the home bar door.

The locking rod, in a state that the home bar door is open, may be released from the locking groove, and if the home bar door is closed, the locking rod may be locked with the locking groove to rotate the other end of the cam toward the rear side.

The case may include a housing in which the cam, the stopper and the torsion spring may be installed, and a cover to cover an upper side of the housing.

A coupling protrusion, to which the one end of the cam may be coupled so as to be rotatable in the front and rear side direction, and the guide rail, may be provided at the housing and the cover.

The housing may be provided with a first coupling hole, to which the stopper may be coupled so as to be rotatable in the upper and lower side direction, and the stopper may be provided with a second coupling hole at a position corresponding to the first coupling hole, so that the stopper may be rotatably coupled to the housing by a rotating shaft inserted into the first coupling hole and the second coupling hole.

The stopper may include a body part making contact with the protrusion part of the switch, and a rotating part having a second coupling hole and configured to rotate in the upper and lower side direction while being coupled to the housing by the rotating shaft. A spring may be provided between the first coupling hole and the second coupling hole to rotate the rotating part in the upper and lower side direction.

The body part may be provided with a first contact part having a tapered shape and making contact with the protrusion part, and the protrusion part may be provided with a second contact part having a shape corresponding to the first contact part and making contact with the first contact part.

In a state that the body part is spaced apart from the protrusion part, the rotating part of the stopper may fix the moving shaft to prevent the moving shaft from moving, and when the first contact part makes contact with the second contact part and thus the body part moves to the rear side, the rotating part may rotate to a lower side direction such that the moving shaft moves along the guide rail.

The cam may include an insertion hole to which the coupling protrusion may be rotatably coupled, and a connection part to which the torsion spring may be connected.

A return spring may be provided at the housing so as to be pressed when the home bar door is closed, and when the home bar door is open, to transmit a pressed compression force in an opening direction of the home bar door to the home bar door.

One side of the return spring may be fixed to the housing and other side of the return spring may be fixed to a fixing protrusion provided at the cam.

When the home bar door is closed, the cam may be rotated toward the rear side while having the insertion hole as a center of rotation to press the return spring, and when the home bar door is open, the cam may be rotated toward the front side while having the insertion hole as a center of rotation by the compression force of the return spring.

The moving shaft may be provided in a circular shape while having an upper side and a lower side, each side having a diameter corresponding to a size of the guide rail such that the moving shaft may be prevented from being separated when moving along the guide rail, and a portion between the upper side and the lower side of the moving shaft may have a diameter smaller than the diameter of each of the upper side and the lower side of the moving shaft so as to be wound by the torsion spring.

The foregoing described problems may be overcome and/or other aspects may be achieved by one or more embodiments of a latch apparatus configured to lock and release a home bar door configured to open and close an opening formed in a door, which may include a switch, a case, a cam, a moving shaft, a stopper, and a torsion spring. The switch may be provided at an upper side of the home bar door and may include a pressing part provided at a front surface thereof and a protrusion part connected to the pressing part while protruding to a rear surface of the switch. The case may be provided at an upper side of the opening while corresponding to a position of the switch, and may be provided at an inside thereof with a guide rail having an elliptical moving path in a front and rear side direction. The cam may be provided at the inside of the case and have a locking groove with which a locking rod provided at an upper side of the home bar door may be locked and released. The moving shaft may be provided so as to be movable in the front and rear side direction along the guide rail. The stopper may be provided at the inside the case and provided so as to be rotatable by the switch in an upper and lower side direction to fix and release the moving shaft. The torsion spring may have one side connected to the cam and another side connected to the moving shaft so as to store a compression force when the home bar door is closed, and when the moving shaft is released by the switch from a fixed state, to transmit the stored compression force in an opening direction of the home bar door to the home bar door, thereby opening the home bar door.

The locking rod, in an open state of the home bar door, may be released from the locking groove, and when the home bar door is closed the locking rod may be locked with the locking groove to rotate the other end of the cam toward a rear side.

The case may include a housing in which the cam, the stopper and the torsion spring may be installed, and a cover to cover an upper side of the housing, and wherein a coupling protrusion, to which one end of the cam may be coupled so as to be rotatable in the front and rear side direction, and the guide rail may be provided at the housing and the cover.

The housing may be provided with a first coupling hole, to which the stopper may be coupled so as to be rotatable in the upper and lower side direction, and the stopper may be provided with a second coupling hole at a position corresponding to the first coupling hole, so that the stopper may be rotatably coupled to the housing by a rotating shaft inserted into the first coupling hole and the second coupling hole.

The stopper may include a body part making contact with the protrusion part of the switch, and a rotating part having the second coupling hole and configured to rotate in the upper and lower side direction while being coupled to the housing by the rotating shaft, and a spring may be provided between the first coupling hole and the second coupling hole to rotate the rotating part in the upper and lower side direction.

The body part may be provided with a first contact part having a tapered shape and making contact with the protrusion part, and the protrusion part may be provided with a second contact part having a shape corresponding to the first contact part and making contact with the first contact part.

In a state that the body part is spaced apart from the protrusion part, the rotating part of the stopper may fix the moving shaft to prevent the moving shaft from moving, and when the first contact part makes contact with the second contact part and thus the body part moves to the rear side, the rotating part may rotate to a lower side direction such that the moving shaft moves along the guide rail.

The cam may include an insertion hole to which the coupling protrusion may be insertedly coupled so as to be rotatably in the front and rear side direction, and a connection part to which the torsion spring may be connected.

A return spring may be provided at the housing so as to be pressed when the home bar door is closed, and when the home bar door is open, to transmit a pressed compression force in an opening direction of the home bar door to the home bar door.

When the home bar door is closed, the cam may be rotated toward the rear side while having the insertion hole as a center of rotation to press the return spring, and when the home bar door is open, the cam may be rotated toward the front side while having the insertion hole as a center of rotation by the compression force of the return spring.

The moving shaft may be provided in a circular shape while having an upper side and a lower side, each side having a diameter corresponding to a size of the guide rail such that the moving shaft may be prevented from being separated when moving along the guide rail, and a portion between the upper side and the lower side of the moving shaft may have a diameter smaller than the diameter of each of the upper side and the lower side of the moving shaft so as to be wound by the torsion spring.

When the home bar door is closed, the other one side of the torsion spring connected to the moving shaft may be fixed and the one side of the torsion spring connected to the cam may be moved to a rear side together with the cam and may be pressed.

In a state that the home bar door is closed, when the pressing part is pressed such that the protrusion part pushes the stopper, the stopper may rotate to a lower side direction, and thus the moving shaft may be moved to the rear side along the guide rail by a compression force of the torsion spring being pressed, and when the moving shaft is moved to the rear side, the cam may be moved to a front side by a remaining compression force of the torsion spring, thereby opening the home bar door.

### BRIEF DESCRIPTION OF THE DRAWINGS

These and/or other aspects will become apparent and more readily appreciated from the following description of embodiments, taken in conjunction with the accompanying drawings of which:

FIG. 1 is a perspective view illustrating a refrigerator according to one or more embodiments.

FIG. 2 is a view illustrating a home bar door and a latch apparatus according to one or more embodiments.

FIG. 3 is an exploded perspective view illustrating the latch apparatus according to one or more embodiments.

FIG. 4 is a cross sectional view illustrating an open state of the home bar door according to one or more embodiments.

FIG. 5 is a cross sectional view illustrating a closed state of the home bar door according to one or more embodiments.

FIG. 6 is a cross sectional view illustrating a state of a switch being pressed to open the home bar door according to one or more embodiments.

FIG. 7 is a cross sectional view illustrating a stopper being rotated to a upper and lower side direction according to one or more embodiments.

FIG. 8 is a cross sectional view illustrating the home bar door being open according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

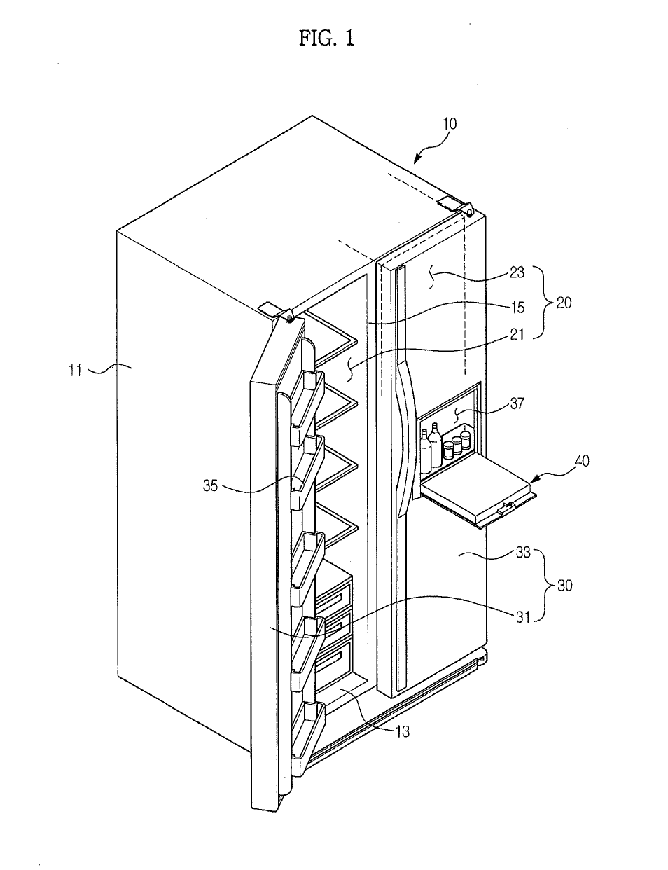

Referring to FIG. 1, a refrigerator may include a body 10, a storage chamber 20 provided at an inside the body 10 so as to be opened at a front surface thereof, a door 30 rotatably coupled to the body 10 to open and close the open front surface of the storage chamber 20 and having an opening 37, a home bar door 40 to open and close the opening 37 formed in the door 30, and a latch apparatus 100 to lock and release the home bar door 40.

Referring to FIG. 1, the body 10 may include an inner case 13 forming the storage chamber 20, an outer case 11 forming the external appearance of the body 10, and a cool air supply apparatus (not shown) to supply the storage chamber 20 with cool air.

The cool air supply apparatus may include a compressor, a condenser, an expansion value, an evaporator, a blower fan, and a cool air duct. A heat insulation material may be formed between the inner case 13 and the outer case 11 to prevent cool air of the storage chamber 20 from leaking.

A machine room (not shown) may be provided at a lower rear portion of the body 10 so that a compressor to compress refrigerant and a condenser to condense the compressed refrigerant may be installed in the machine room.

The storage chamber 20 may be divided into a freezing chamber 21 and a refrigerating chamber 23 by a partition wall 15, and the open front surface of the storage chamber 20 may be opened and closed by the door 30.

The door 30 may include a freezing chamber door 31 to open and close the freezing chamber 21 and a refrigerating chamber door 33 to open and close the refrigerating chamber 23, and a plurality of shelves 35 may be installed at a rear surface of the door 30 to accommodate foodstuff.

The opening 37 corresponding to a separate storage space having a small size when compared to the refrigerating door 33 may be provided in the refrigerating door 33. The opening 37 may be open and closed by the home bar door 40.

Since the opening 37 having a separate storage space with a small size may be provided in the refrigerator door 33 as described above and the opening 37 may be open and closed by the home bar door 40, beverages and the like contained at an inside the opening 37 may be taken out of or put in through the home bar door 40 without opening the refrigerating door 33.

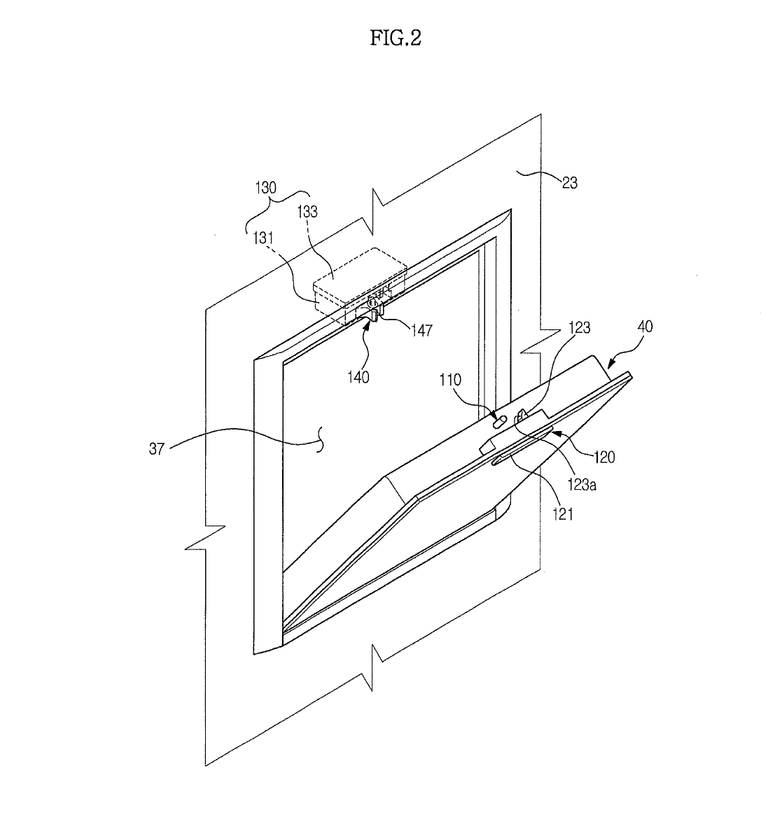

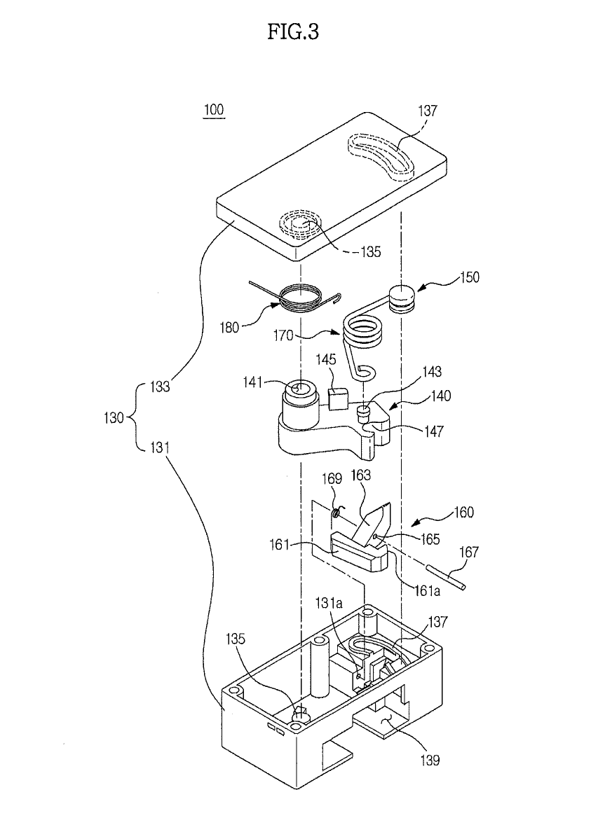

Referring to FIGS. 2 to 4, the latch apparatus 100 may include a locking rod 110 provided at an upper side of the home bar door 40, a switch 120 provided at an upper side of the home bar door 40 and allowing the home bar door 40 to be open when a user pushes the switch 120, a case 130 provided at an upper side of the opening 37 at a position corresponding to the switch 120 and provided at an inside thereof with a guide rail 137 having an elliptical moving path in a front and rear side direction, a cam 140 rotatably installed so as to be rotatable in the front and rear side direction at the inside of the case 130, a moving shaft 150 provided so as to be movable in the front and rear side direction along the guide rail 137, a stopper 160 provided to fix and release the moving shaft 150, and a torsion spring 170 having one side connected to the cam 140 and the other side connected to the moving shaft 150 so as to open the home bar door 40 by a compression force.

The locking rod 110 may be provided at an upper side of the home bar door 40 to allow the home bar door 40 to be locked and released.

In a case in which the home bar door 40 is closed, the locking rod 110 may be locked with a locking groove 147 formed in the cam 140 that is to be described later, so that the home bar door 40 may be maintained in a closed stated. In a case of opening the home bar door 40, the locking rod 110 may be released from the locking groove 147 such that the home bar door 40 is open.

In a case of closing the home bar door 40, the locking rod 110 may be locked with the locking groove 147 formed in the cam 140. In an open state of the home bar door 40, the locking groove 147 of the cam 140 is in a state of being rotated toward the front side to protrude to the outside the case 130, and in a case of closing the home bar door 40, the locking rod 110 may be locked with the locking groove 147 to rotate the cam 140 toward the rear side while having an insertion hole 141 as a center of rotation.

The switch 120 may be provided at an upper side of the home bar door 40, and may include a pressing part 121 provided at a front surface of the switch 120 and a protrusion part 123 protruding to a rear surface of the switch 120 while being connected to the pressing part 121.

The protrusion part 123 may have a second contact part 123a that may push the stopper 160 while making contact with a first contact part 161a of the stopper 160, and the first contact part 161a and the second contact part 123a may be provided in a tapered shape corresponding to each other.

As for the structure of the switch 120, the pressing part 121 may protrude toward to a front side so as to be pushed by a user, and the protrusion part 123 connected to the pressing part 121 may be provided to be moved to a rear side when a user pushes the pressing part 121, so that the stopper 160 installed at an inside the case 130 is pushed.

Accordingly, in a closed state of the home bar door 40, when a user pushes the pressing part 121 of the switch 120, the protrusion part 123 connected to the pressing part 121 may be moved to the rear side to push the stopper 160, thereby opening the home bar door 50. The process of opening the home bar door 40 will be described later.

The case 130 may be provided at an upper side of the opening 37 at a position corresponding to the switch 120, and may include a housing 131, in which the cam 140, the stopper 160 and the torsion spring 170 are installed, and a cover 133 configured to cover an upper side of the housing 131.

At both of the housing 131 and the cover 133, a coupling protrusion 135, inserted into the insertion hole 141 of the cam 140, and the guide rail 137 having an elliptical moving path in the front and rear side direction and allowing the moving shaft 150 to be moved therealong may be provided.

As the coupling protrusions 135 provided at the housing 131 and the cover 133 are inserted into the insertion hole 141 of the cam 140, the cam 140 may be installed at the case 130 so as to be rotatable in the front and rear side direction while having the coupling protrusion 135 as a center of rotation.

The housing 131 may be provided with a first coupling hole 131a to which the stopper 160 is coupled, and the stopper 160 may be provided with a second coupling hole 165 at a position corresponding to the first coupling hole 131a. Accordingly, as a rotating shaft 167 is inserted into the first coupling hole 131a and the second coupling hole 165, the stopper 160 may be coupled to the housing 131 so as to be rotatable in an upper and lower side direction.

An opening 139 may be provided at a front surface of the housing 131 such that the other end of the cam 140 installed at an inside the housing 131 may protrude to the outside the housing 131 after rotating in the front and rear side direction while having the insertion hole 141 as the center of rotation.

In addition, through the opening 139 of the housing 131, the protrusion part 123 of the switch 120 may push the stopper 160 installed at an inside the housing 131.

The cam 140 may include the insertion hole 141 rotatably coupled to the coupling protrusion 135 provided at the case 130, a connection part 143 to which the torsion spring 170 may be connected, a fixing protrusion 145 to which a return spring 180 may be fixed, and a locking groove 147 with which the locking rod 110 may be locked and released.

The cam 140 may be installed while having the other end rotated in the front and rear side direction with respect to the insertion hole 141 provided at one end of the cam 140. In an open state of the home bar door 40, the other end of the cam 140 provided with the locking groove 147 may rotate toward the front side and thus may protrude to the outside the housing 131.

In a state in which the other end of the cam 140 protrudes to the outside the housing 131, when the home bar door 40 is closed, the locking rod 110 provided at a upper side of the home bar door 40 may be locked with the locking groove 147 to push the other end of the cam 140 to the rear side.

When the other end of the cam 140 rotates toward the rear side while having the insertion hole 141 as a center of rotation, and moves to the inside the housing 131, since the locking rod 110 may be maintained in a state of being locked with the locking groove 147, the home bar door 40 may become in a locked state.

When the home bar door 40 is to be opened, the locking rod 110 may be maintained in a state of being locked with the locking groove 147. Accordingly, as the other end of the cam 140 is rotated to the front side together with the locking rod 110 while having the insertion hole 141 as the center of rotation, and protrudes to the outside the housing 131, the locking rod 110 may be released from the locking groove 147, and thus the home bar door 40 may be opened.

The moving shaft 150 may be installed so as to be movable in the front and rear side direction along the guide rail 137 provided in the case 130, and may be connected to the torsion spring 170.

The moving shaft 150 may be provided in a circular shape while having an upper side and a lower side thereof each having a diameter corresponding to a size of the guide rail 137 to prevent the moving shaft 150 from being separated from the guide rail 137, and a portion between the upper side and the lower side of the moving shaft 150 may have a diameter smaller than the diameter of each of the upper side and the lower side of the moving shaft 150 so as to be wound by the torsion spring 170.

In a closed state of the home bar door 40, the moving shaft 150 may be kept in a fixed state by the stopper 160 while being prevented from being moved, and when a user pushes the pressing part 121 of the switch 120 so that the protrusion part 123 pushes the stopper 160, the stopper 160 may be rotated to release the moving shaft 150 from being fixed by the stopper 160, and thus the moving shaft 150 may be moved to the rear side by a compression force of the torsion spring 170.

If the moving shaft 150 is moved up to the rear side of the guide rail 137, a remaining compression of the torsion spring 170 may rotate the other end of the cam 140 connected to the torsion spring 170 toward the front side while having the insertion hole 141 as the center of rotation, and the locking rod 110 locked with the locking groove 147 may be released from the locking groove 147, thereby opening the home bar door 40.

The stopper 160 may include a body part 161 making contact with the protrusion 123 of the switch 120 and a rotating part 163 provided with the second coupling hole 165 enabling the stopper 160 to be rotatably coupled to the housing 131, so that the rotating part 163 may be rotated in the upper and lower side direction while being coupled to the housing 131 by the rotating shaft 167.

When the stopper 160 is coupled to the housing 131, a spring 169 may be installed between the first coupling hole 131a provided at the housing 131 and the second coupling hole 165 provided at the stopper 160 so as to rotate the rotating part 163 in the upper and lower side direction.

At the body part 161, the first contact part 161a provided in a tapered shape to make contact with the protrusion part 123 of the switch 120 may be provided.

When a user pushes the pressing part 121 of the switch 120 to move the protrusion part 123 to the rear side, the second contact part 123a provided at the protrusion part 123 may push the first contact part 161a provided at the body part 161 of the stopper 160, and as the body part 161 is pushed by the protrusion part 123, the rotating part 163 connected to the body part 161 may be rotated to the lower side while having a connection portion between the rotating part 163 and the body part 161 as a center of rotation to release the moving shaft 150 from the fixed state, thereby moving the moving shaft 150 along the guide rail 137.

The torsion spring 170 may be provided with one side thereof connected to the cam 140, and the other side thereof connected to the moving shaft 150, and may allow the home bar door 40 to be opened by a compression force.

The torsion spring 170 may store a compression force while being pressed when the home bar door 40 is closed, and when a user pushes the switch 120 to release the moving shaft 150 from being fixed by the stopper 160, the stored compression force may be transmitted to the cam 140 in an opening direction of the home bar door 40 such that the home bar door 140 may be opened. The process of opening the home bar door 40 will be described later.

At the housing 131, the return spring 180 may be provided to store a compression force while being pressed when the home bar door 40 is closed, and when the home bar door 40 is open, to transmit the stored compression force in an opening direction of the home bar door 40 to the cam 140, so that the home bar door 40 may be opened.

One side of the return spring 180 may be fixed to the housing 131, and the other side of the return spring 180 may be fixed to the fixing protrusion 145 provided at the cam 140.

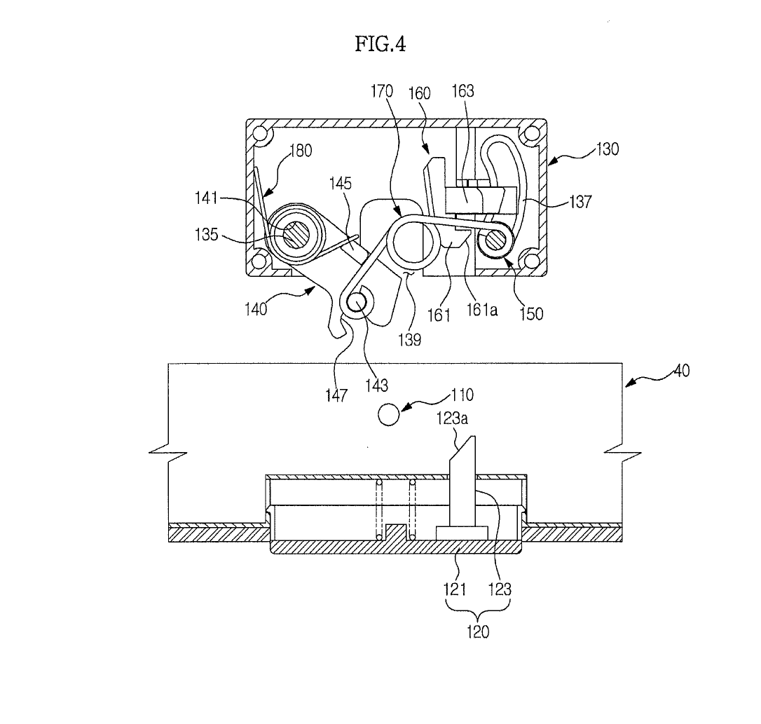

Thereafter, a process of opening and closing the home bar door will be described with reference to FIGS. 4 through 8.

First, as shown in FIG. 4, in an open state of the home bar door 40, the cam 140 installed at an inside the case 130 may be in a state of being rotated toward the front side while having the insertion hole 141 as a center of rotation such that the locking groove 147 provided at the other end of the cam 140 may protrude to the outside the case 130.

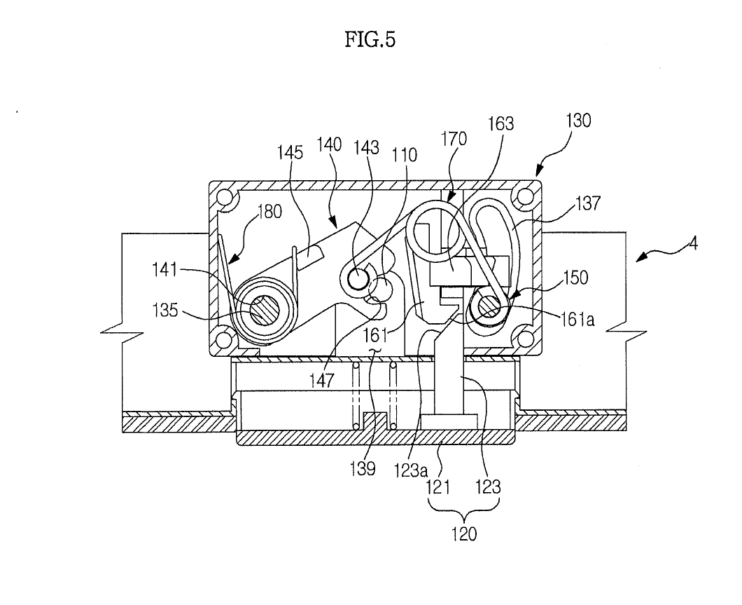

From an open state of the home bar door 40, when the home bar door 40 is closed as shown in FIG. 5, the locking rod 110 provided at the upper side of the home bar door 40 may be locked with the locking groove 147 of the cam 140 to push the other end of the cam 140 provided with the locking groove 147.

If the other end of the cam 140 is pushed to the rear side by the locking rod 110, the other end of the cam 140 may be rotated toward the rear side while having the insertion hole 14 as the center of rotation, and may be moved to the inside the case 130. In this case, the home bar door 40 may be closed in a state of the locking rod 110 being locked with the locking groove 146, and thus the home bar door 40 may be in a locked state.

When the other end of the cam 140 is rotated toward the rear side while having the insertion hole 141 as the center of rotation, since the moving shaft 150 is fixed by the stopper 160, the other side of the torsion spring 170 connected to the moving shaft 150 may be fixed, and the one side of the torsion spring 170 connected to the cam 140 may be moved to the rear side together with the other end of the cam 140 to store a compression force while being pressed.

In addition, since one side of the return spring 180 installed at an inside the case 130 may be fixed to the housing 131, and the other side of the return spring 180 may be fixed to the fixing protrusion 145 of the cam 140, as the other side of the return spring 180 fixed to the fixing protrusion 145 of the cam 140 is rotated together with the other end of the cam 140 to store a compression force while being pressed.

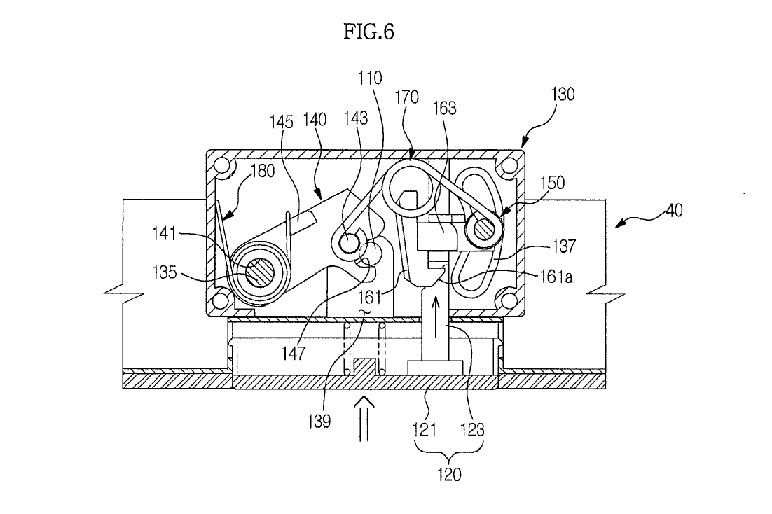

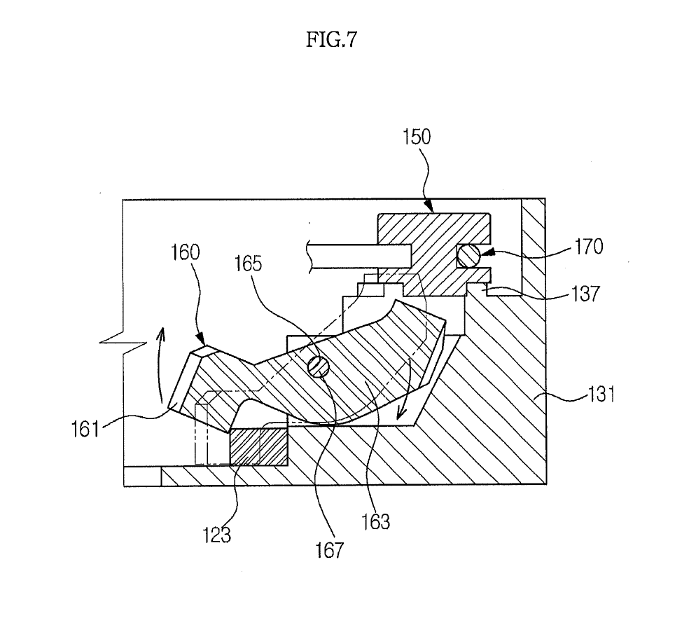

In a state in which the home bar door 40 is closed, when a user pushes the pressing part 121 of the switch 120 indicated as an arrow in FIGS. 6 and 7 to open the home bar door 40, the protrusion part 123 connected to the pressing part 121 may be moved to the rear side so that the second contact part 123a of the protrusion part 123 may make contact with the first contact part 161a provided at the body part 161 of the stopper 160.

As the second contact part 123a of the protrusion part 123 makes contact with the first contact part 161a of the stopper 160 to push the body part 161 of the stopper 160, the rotating part 163 of the stopper 160 may be rotated to the lower side direction with respect to the connection portion between the rotating part 163 and the body part 161.

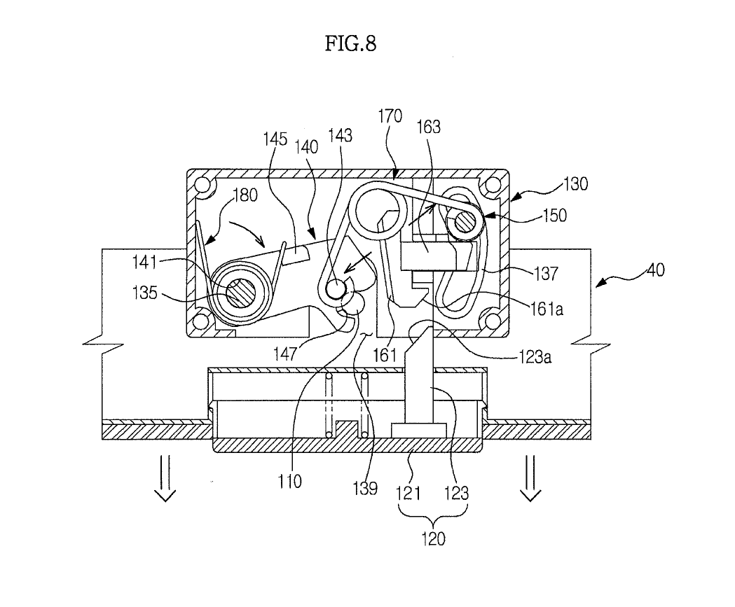

As the rotating part 163 of the stopper 160 is rotated to the lower side direction, the moving shaft 150 may be released from being fixed by the stopper 160 as shown in FIG. 8, the moving shaft 150 may be moved to the rear side of the guide rail 137 along the guide rail 137 by the compression force of the torsion spring 170.

In this case, since the one side of the torsion spring 170 is connected to the connection part 143 of the cam 140, and the other side of the torsion spring 170 is connected to the moving shaft 150, the one side of the torsion spring 170, which is connected to the connection part 143 of the cam 140, may be fixed after being rotated to the rear side and the other side of the torsion spring 170 connected to the moving shaft 150 may be moved together with the moving shaft 150.

The torsion spring 170 may have a remaining compression force stored even after the other side of the torsion spring 170 moves to the rear side of the guide rail 137 together with the moving shaft 150.

The other side of the torsion spring 170 may be fixed after being moved to the rear side of the guide rail 137 together with the moving shaft 150, and the remaining compression force may be transmitted to the cam 140 connected to the one side of the torsion spring 170.

According to the compression force being transmitted to the cam 140, a portion of the cam 140 having the locking groove 147 may rotate toward the front side while having the insertion hole 141 as the center of rotation.

As the portion of the cam 140 having the locking groove 147 is rotated, the locking groove 147 may push the locking rod 110 provided at the home bar door 40 to open the home bar door 40.

In this case, since the compression force of the return spring 180 as well as the compression force of the torsion spring 170 may be transmitted to the cam 140, the portion of the cam 140 having the locking groove 147 may be rotated toward the front side to protrude to the outside the case 130, thereby pushing the locking rod 110.

As the portion of the cam 140 having the locking groove 147 protrudes to the outside the case 130, the locking rod 110 locked with the locking groove 147 may be released so that the home bar door 40 may be opened.

As is apparent from the above description, one or more embodiments allow the home bar door to be locked and opened.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A refrigerator comprising a body, a door configured to open and close a front surface of the body and having an opening, a home bar door configured to open and close the opening, and a latch apparatus configured to lock and release the home bar door, the latch apparatus comprising:
a locking rod provided at an upper side of the home bar door;
a switch provided at an upper side of the home bar door and comprising a pressing part provided at a front surface of the switch and a protrusion part connected to the pressing part and protruding from a rear surface of the switch;
a case provided at an upper side of the opening corresponding to a position of the switch, and comprising a guide rail having an elliptical moving path;
a cam having one end installed inside the case so as to be rotatable and another end provided with a locking groove;
a moving shaft provided so as to be movable along the guide rail;
a stopper provided inside the case so as to be rotatable to fix and release the moving shaft; and
a torsion spring having one side connected to the cam and another side connected to the moving shaft so that, when the home bar door is closed, the other side of the torsion spring connected to the moving shaft is fixed and the one side of the torsion spring connected to the cam is moved to a rear side of the case together with the cam,
wherein in a state that the home bar door is closed, when the pressing part is pressed such that the protrusion part pushes the stopper, the stopper rotates to a lower side direction, the moving shaft is moved to the rear side along the guide rail by a compression force of the torsion spring being pressed, and the cam is moved to a front side by the compression force of the torsion spring.

2. The refrigerator of claim 1, wherein when the home bar door is open the locking rod is released from the locking groove, and when the home bar door is closed the locking rod is locked with the locking groove to rotate the other end of the cam toward the rear side.

3. The refrigerator of claim 1, wherein the case comprises a housing in which the cam, the stopper and the torsion spring are installed, and a cover to cover an upper side of the housing.

4. The refrigerator of claim 3, wherein a coupling protrusion, to which the one end of the cam is coupled so as to be rotatable, and the guide rail are provided at the housing and the cover.

5. The refrigerator of claim 4, where the housing is provided with a first coupling hole, to which the stopper is coupled so as to be rotatable, and the stopper is provided with a second coupling hole at a position corresponding to the first coupling hole, so that the stopper is rotatably coupled to the housing by a rotating shaft inserted into the first coupling hole and the second coupling hole.

6. The refrigerator of claim 5, wherein the stopper comprises a body part making contact with the protrusion part of the switch, and a rotating part having the second coupling hole and configured to rotate while being coupled to the housing by the rotating shaft, and a spring is provided between the first coupling hole and the second coupling hole to rotate the rotating part.

7. The refrigerator of claim 6, wherein the body part is provided with a first contact part having a tapered shape and making contact with the protrusion part, and the protrusion part is provided with a second contact part having a shape corresponding to the first contact part and making contact with the first contact part.

8. The refrigerator of claim 7, wherein when the body part is spaced apart from the protrusion part the rotating part of the stopper fixes the moving shaft to prevent the moving shaft from moving, and when the first contact part makes contact with the second contact part and thus the body part moves to a rear side, the rotating part rotates to a lower side direction such that the moving shaft moves along the guide rail.

9. The refrigerator of claim 4, wherein the cam comprises an insertion hole to which the coupling protrusion is rotatably coupled, and a connection part to which the torsion spring is connected.

10. The refrigerator of claim 9, wherein a return spring is provided at the housing so as to be pressed when the home bar door is closed, and to transmit a pressed compression force in an opening direction of the home bar door to the home bar door when the home bar door is open.

11. The refrigerator of claim 10, wherein one side of the return spring is fixed to the housing and another side of the return spring is fixed to a fixing protrusion provided at the cam.

12. The refrigerator of claim 11, wherein when the home bar door is closed, the cam is rotated toward the rear side while having the insertion hole as a center of rotation to press the return spring, and when the home bar door is open the cam is rotated toward the front side by the compression force of the return spring while having the insertion hole as a center of rotation.

13. The refrigerator of claim 1, wherein the moving shaft is provided in a circular shape having an upper side and a lower side, each side having a diameter corresponding to a size of the guide rail such that the moving shaft is engaged with the guide rail when moving along the guide rail, and a portion between the upper side and the lower side of the moving shaft has a diameter smaller than the diameter of each of the upper side and the lower side of the moving shaft so as to be wound by the torsion spring.

14. A latch apparatus configured to lock and release a home bar door configured to open and close an opening formed in a door, the latch apparatus comprising:
a switch provided at an upper side of the home bar door and comprising a pressing part provided at a front surface thereof and a protrusion part connected to the pressing part and protruding from a rear surface of the switch;
a case provided at an upper side of the opening corresponding to a position of the switch, and comprising a guide rail having an elliptical moving path;
a cam provided inside the case and having a locking groove with which a locking rod provided at an upper side of the home bar door is locked and released;
a moving shaft provided so as to be movable along the guide rail;
a stopper provided inside the case and provided so as to be rotatable by the switch to fix and release the moving shaft; and
a torsion spring having one side connected to the cam and another side connected to the moving shaft so as to store a compression force when the home bar door is closed, and when the moving shaft is released by the switch from a fixed state, to transmit the stored compression force in an opening direction of the home bar door to the home bar door.

15. The latch apparatus of claim 14, wherein when the home bar door is open the locking rod is released from the locking groove, and when the home bar door is closed the locking rod is locked with the locking groove to rotate the other end of the cam toward a rear side.

16. The latch apparatus of claim 14, wherein the case comprises a housing in which the cam, the stopper and the torsion spring are installed, and a cover to cover an upper side of the housing, and wherein a coupling protrusion, to which one end of the cam is coupled so as to be rotatable, and the guide rail are provided at the housing and the cover.

17. The latch apparatus of claim 16, wherein the housing is provided with a first coupling hole, to which the stopper is coupled so as to be rotatable, and the stopper is provided with a second coupling hole at a position corresponding to the first coupling hole, so that the stopper is rotatably coupled to the housing by a rotating shaft inserted into the first coupling hole and the second coupling hole.

18. The latch apparatus of claim 17, wherein the stopper comprises a body part making contact with the protrusion part of the switch, and a rotating part having the second coupling hole and configured to rotate while being coupled to the housing by the rotating shaft, and a spring is provided between the first coupling hole and the second coupling hole to rotate the rotating part.

19. The latch apparatus of claim 18, wherein the body part is provided with a first contact part having a tapered shape and making contact with the protrusion part, and the protrusion part is provided with a second contact part having a shape corresponding to the first contact part and making contact with the first contact part.

20. The latch apparatus of clam 19, wherein when the body part is spaced apart from the protrusion part the rotating part of the stopper fixes the moving shaft to prevent the moving shaft from moving, and when the first contact part makes contact with the second contact part and thus the body part moves to a rear side, the rotating part rotates to a lower side direction such that the moving shaft moves along the guide rail.

21. The latch apparatus of claim 16, wherein the cam comprises an insertion hole to which the coupling protrusion is rotatably coupled, and a connection part to which the torsion spring is connected.

22. The latch apparatus of claim 21, wherein a return spring is provided at the housing so as to be pressed when the home bar door is closed, and to transmit a pressed compression force in an opening direction of the home bar door to the home bar door when the home bar door is open.

23. The latch apparatus of claim 22, wherein when the home bar door is closed the cam is rotated toward the rear side while having the insertion hole as a center of rotation to press the return spring, and when the home bar door is open the cam is rotated toward the front side by the compression force of the return spring while having the insertion hole as a center of rotation.

24. The latch apparatus of claim 14, wherein the moving shaft is provided in a circular shape while having an upper side and a lower side, each side having a diameter corresponding to a size of the guide rail such that the moving shaft is engaged with the guide rail when moving along the guide rail, and a portion between the upper side and the lower side of the moving shaft has a diameter smaller than the diameter of each of the upper side and the lower side of the moving shaft so as to be wound by the torsion spring.

25. The latch apparatus of claim 14, wherein when the home bar door is closed, the other one side of the torsion spring connected to the moving shaft is fixed and the one side of the torsion spring connected to the cam is moved to a rear side together with the cam.

26. The latch apparatus of claim 25, wherein in a state that the home bar door is closed, when the pressing part is pressed such that the protrusion part pushes the stopper, the stopper rotates to a lower side direction, and moving shaft is moved to the rear side along the guide rail by a compression force of the torsion spring being pressed, and the cam is moved to a front side by the compression force of the torsion spring.
